(19) United States
(12) Patent Application Publication
(10) Pub. No.: US 2008/0049113 A1
(43) Pub. Date: Feb. 28, 2008

(54) IMAGE SENSING APPARATUS

(75) Inventor: Yuichi Hirai, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Tokyo (JP)

(21) Appl. No.: 11/776,831

(22) Filed: Jul. 12, 2007

(30) Foreign Application Priority Data
Jul. 13, 2006 (JP) 2006-193231(PAT.)

(51) Int. Cl. H04N 5/228

(52) U.S. Cl. 348/222.1; 348/E05.031

(57) ABSTRACT

An image sensing apparatus includes a dividing unit which divides image data into at least first and second divided image data; a first hash calculation unit which calculates first hash value from the first divided image data; a second hash calculation unit which calculates second hash value from the second divided image data, said second hash calculation unit being operated in parallel with said first hash calculation unit; and an alteration detecting information generating unit which generates alteration detecting information from each of the first and second hash value.

### BACKGROUND OF THE INVENTION

1. Field of the Invention

The present invention relates to an apparatus, method and computer program capable of generating alteration detecting information which is used to detect whether or not image data is altered.

2. Description of Related Art

As is conventionally well known, a digital camera having a semiconductor image sensing element such as a CCD or C-MOS sensor has a function of receiving a moving image signal or a still image signal as an image signal, digitizing the signal, and storing the image data in a storage medium such as a semiconductor memory. Along with the recent progress of semiconductor technologies, semiconductor image sensing elements with, e.g., 6,000,000 pixels to more than 10,000,000 pixels have been developed and used. Hence, the quality of image data sensed by digital cameras including such a semiconductor image sensing element with an enormous number of pixels is remarkably improving. Some digital cameras are consequently making an entry into fields where silver halide cameras are used formerly. For example, digital cameras are used to take photographs to be published on newspapers and magazines or to take identification photographs.

While the digital cameras are finding such new application fields, the focus falls on handling of photographs as distribution items and the believability of photographs themselves. Image data is an electrical signal and is therefore alterable more easily than photographs created by a silver halide camera. Without a solution to this problem, image data whose believability is uncertain is unacceptable as formal evidence.

There are conventionally several proposals about how to generate, sign, and record alteration detecting data for image data sensed by a digital camera. For example, Japanese Patent Laid-Open No. 2002-010044 discloses an invention that stores image data in an image area and signature data in a property area in saving generated image file data in a recording medium.

FIG. 1 is a block diagram showing an example of an alteration detecting information generating unit of prior art. Referring to FIG. 1, a processing unit 101 controls the overall device and normally includes a CPU and a ROM that stores a control program to control the overall device. The processing unit 101 controls shooting processing, development processing, and image file data generation processing. FIG. 1 does not illustrate parts necessary for shooting processing. A work memory 105 in FIG. 1 stores, as image file data A, B and C, image data as a processing target obtained from an image sensing unit (not shown).

A file management register 102 in FIG. 1 holds the attributes (e.g., size and storage address) of each image file data. The processing unit 101 reads out the attributes of image file data as a processing target from the file management register 102 and transfers them to a memory control register 103. The memory control register 103 stores the received attributes of image file data.

The memory control register 103 designates, to a memory control unit 104, the address and size of image file data to be read out as a processing target. The memory control unit 104 controls to issue “status” to the work memory 105 and actually read or write the image file data from or in the work memory 105.

Referring to FIG. 1, a hash calculation unit 106 executes hash calculation. Hash calculation is traditionally commonly used as an alteration detecting means. A hash function is a one-way function which obtains operand data (input message: image file data in this case) from the result of the function. Before processing, the processing unit 101 must initialize the hash calculation unit 106.

Image file data read out from the work memory 105 is transferred to the hash calculation unit 106 and subjected to hash calculation. A signature calculation unit 107 uses a processing method such as SHA1. The signature calculation unit 107 signs the processing output result (to be referred to as a digest value hereinafter) from the hash calculation unit 106 by using key information unique to a device (e.g., digital camera with specified model name and serial number). Hence, when signature data unique to a digital camera (device) is added to image data (file) obtained upon shooting by the digital camera (device), the image file data can safely be extracted from the digital camera (device) and taken out.

The hash calculation unit 106 of the prior art described with reference to FIG. 1 must execute hash calculation of an input message (image file data) a plurality of number of times. The throughput of the digital camera drops only via the hash calculation unit 106. For example, an MD5 Message-Digest Algorithm (to be referred to as an “MD5 algorithm” hereinafter) requires four operations of hash calculation per word of an input message. That is, even when an operation of hash calculation is executed in a clock as hardware processing, the processing time increases to four-fold for an input message (image file data). For this reason, it is difficult from the viewpoint of speed for, e.g., a digital camera that implements high-speed continuous shooting to control to generate alteration detecting digest values simultaneously with high-speed continuous shooting.

### SUMMARY OF THE INVENTION

The present invention is directed to overcome the above-described drawbacks and disadvantages.

The present invention is directed to generate alteration detecting information, which is used to detect whether or not image data is altered, more rapidly or efficiently.

According to an aspect of the present invention, there is provided an image sensing apparatus comprising: a dividing unit which divides image data into at least first and second divided image data; a first hash calculation unit which calculates first hash value from the first divided image data; a second hash calculation unit which calculates second hash value from the second divided image data, the second hash calculation unit being operated in parallel with the first hash calculation unit; and an alteration detecting information generating unit which generates alteration detecting information from each of the first and second hash values.

Further features and aspects of the present invention will become apparent from the following description of exemplary embodiments with reference to the attached drawings.

### BRIEF DESCRIPTION OF THE DRAWINGS

FIG. 1 is a block diagram of the main part of an alteration detecting information generating unit according to a prior art;

FIG. 2 is a block diagram of the main part of an alteration detecting information generating unit applied to a digital camera according to a first exemplary embodiment of the present invention;

FIGS. 3A to 3D are views for explaining the contents of registers included in the alteration detecting information generating unit of the digital camera according to the first exemplary embodiment of the present invention; and

FIG. 4 is a flowchart for explaining the operation of the alteration detecting information generating unit according to the first exemplary embodiment of the present invention.

### DESCRIPTION OF THE EMBODIMENTS

Exemplary embodiments, features and aspects of the present invention will now be described in detail below with reference to the attached drawings.

### First Exemplary Embodiment

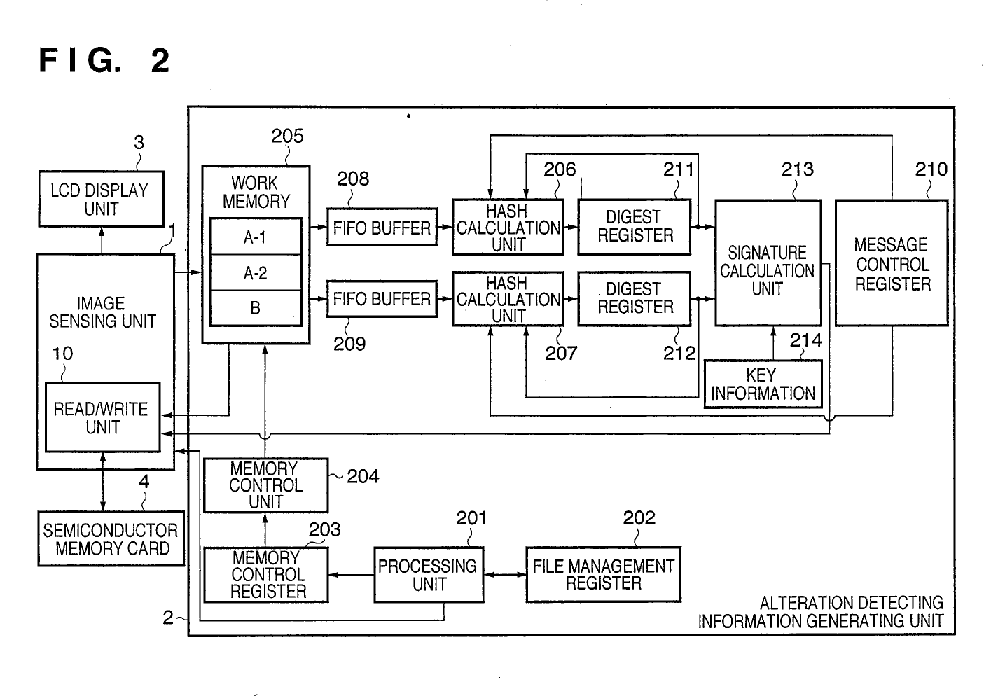

FIG. 2 is a block diagram of the main part of a digital camera according to the first exemplary embodiment of the present invention. The digital camera shown in FIG. 2 is one example of an image sensing apparatus, and is also one example of an alteration detecting information generating apparatus. Referring to FIG. 2, the digital camera includes an image sensing unit 1, alteration detecting information generating unit 2, LCD display unit 3, and detachable semiconductor memory card 4. The alteration detecting information generating unit 2 generates alteration detecting information from image data provided from the image sensing unit 1. The alteration detecting information is used to detect an alteration of the image data. The LCD display unit 3 is provided to monitor an object image before or after shooting or image data stored on the semiconductor memory card 4. The image sensing unit 1 including an optical system, semiconductor image sensing element, signal processing circuit, and digital conversion circuit outputs image data representing a sensed image. A detailed description of these components and their operations will be omitted in this specification.

The digital camera shown in FIG. 2 implements high-speed processing by dividing sensed image data (image file data) into a plurality of regions, simultaneously generating hash values in parallel, and signing them. In the first exemplary embodiment, a “hash value” is also referred to as a “digest value”.

In the first exemplary embodiment, hash calculation of image file data by the alteration detecting information generating unit 2 will be described in detail. Other operations including image sensing and development processing are well known, and a detailed description thereof will be omitted.

Image file data A and B obtained by the image sensing unit 1 of the digital camera are temporarily stored in a volatile memory such as a DRAM serving as a temporary storage means until they are finally recorded on a nonvolatile memory such as the semiconductor memory card 4. A work memory 205 serves as such temporary storage means. Image file data is not only recorded on a recording medium such as an HDD or magnetooptical disk but may also be transferred to an external storage device via an I/F (not shown) provided on the digital camera.

In the alteration detecting information generating unit 2 shown in FIG. 2, a processing unit 201 controls the digital camera and normally includes a CPU (central processing unit) and a ROM (read only memory) that stores a control program to control the digital camera. The processing unit 201 executes control of shooting processing, development processing, and image file data generation processing, including control of the image sensing unit 1. As described above, the work memory 205 in FIG. 2 temporarily stores, as the image file data A and B, image data as a processing target obtained from the image sensing unit 1.

A file management register 202 holds the attributes (e.g., size and storage address) of each image file data stored in the work memory 205. The file management register 202 may be allocated in the work memory 205. The processing unit 201 reads out the attributes of image file data as a processing target from the file management register 202 and transfers them to a memory control register 203. The memory control register 203 stores the received attributes of image file data.

The memory control register 203 designates, to a memory control unit 204, the address and size of image file data to be read out as a processing target. The memory control unit 204 controls to issue “status” to the work memory 205 and actually read or write the image file data from or in the work memory 205.

Assume that the image file data A exists in the work memory 205. If a setting on the digital camera body requests addition of alteration detecting information, the image file data A obtained upon shooting is defined as an image file data processing target and subjected to hash calculation.

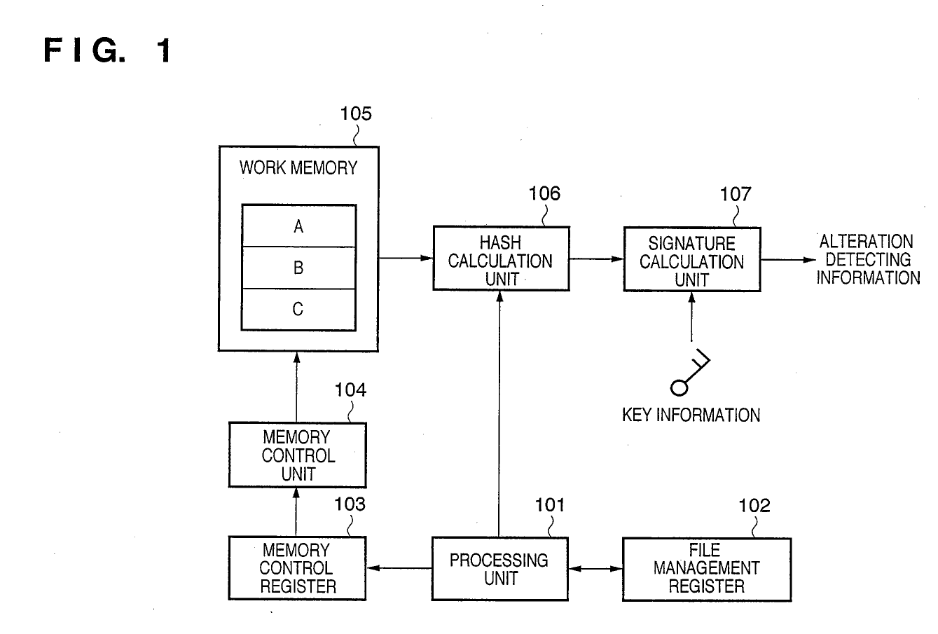

In the conventional control method described with reference to FIG. 1, digest processing is executed one-dimensionally for target image file data. In MD5 algorithm processing, four operations of hash calculation are executed per word to obtain digest values. Hash calculation executed by reading one word in a clock as hardware processing takes a processing time of at least four times. In practice, 16 words each containing 32 bits is processed as a pair.

In the first exemplary embodiment, two hash calculation units 206 and 207 are arranged in parallel. The target image file data A is divided into two regions A-1 and A-2. The hash calculation units 206 and 207 execute hash calculation simultaneously for the two divided image file data regions A-1 and A-2. This effectively doubles the speed of processing the target image file data A.

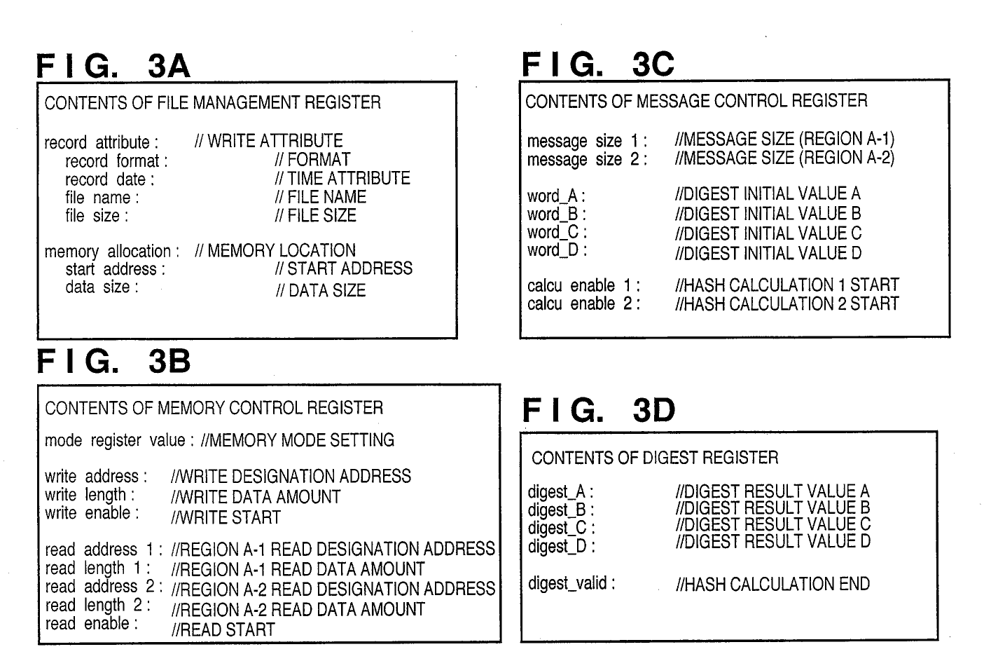

More specifically, the processing unit 201 reads out the attributes of the image file data A from the file management register 202. The attributes of the image file data A include, e.g., items shown in FIG. 3A. In this example, pieces of information (e.g., start address and data size) necessary for reading out the target image file data A from the work memory 205 are selected.

The memory control register 203 stores the readout pieces of attribute information. The memory control register 203 also store, e.g., items shown in FIG. 3B. In FIG. 3B, “mode register value” indicates a mode set value (e.g., burst count) when the work memory 205 uses an SDRAM. This value is set in the initial operation of the digital camera (device).

In the first exemplary embodiment, the data amounts of the regions A-1 and A-2 in the data read out by the processing unit 201 are calculated. In accordance with the calculated values, the memory control register 203 sets “read addresses” 1 and 2 in FIG. 3B as read start addresses and “read lengths” 1 and 2 as read amounts. With these settings, the region of the target image file data A is divided into the two divided image file data regions A-1 and A-2.

The processing unit 201 sets, in the memory control register 203, a data write/read start flag (“write/read enable” in FIG. 3B) for the work memory 205. The memory control register 203 sends the set start flag to the memory control unit 204. Upon receiving the flag, the memory control unit 204 controls “status” of access to the work memory 205.

In the first exemplary embodiment, the read operation from the work memory 205 is performed. The memory control register 203 sets, in the memory control unit 204, address values representing the two divided image file data regions A-1 and A-2. Upon detecting the memory read flag, the memory control unit 204 accesses the work memory 205 while alternately updating the addresses of the divided image file data regions A-1 and A-2. FIFO buffers 208 and 209 buffer the divided image file data read out from the work memory 205 and input them to the hash calculation units 206 and 207 of the next stage.

Normally, the bus bandwidth of the work memory 205 is designed to be wider than that of inputs to the hash calculation units 206 and 207. For this reason, even the alternate readout data are regarded to be simultaneously processed as inputs to the hash calculation units 206 and 207. The resulting readout data of the two divided image file data regions A-1 and A-2 are input to the hash calculation units 206 and 207, respectively. The hash calculation unit 206 calculates a hash value from data of the divided image file data region A-1. The hash calculation unit 207 calculates a hash value from data of the divided image file data region A-2 in parallel with the hash calculation unit 206.

Before the start of processing, a message control register 210 initializes the hash calculation unit 206. Set items include, e.g., items shown in FIG. 3C. Referring to FIG. 3C, for example, “message size” is added after input divided image file data (message) and used in executing hash calculation. When a digest value contains four words, word_A, word_B, word_C, and word_D are set as initial values. For example, the MD5 algorithm sets

word_A: 01 23 45 67: hexadecimal number

word_B: 89 ab cd ef: hexadecimal number

word_C: fe dc ba 98: hexadecimal number

word_D: 76 54 32 10: hexadecimal number

### The same initialization is done even between the hash calculation unit 207 and the message control register 210.

The message control register 210 enables hash calculation start flags “calcu enable 1 and calcu enable 2” in FIG. 3C and then stands by before the start of processing.

Assuming that the divided image file data regions A-1 and A-2 to be processed by the hash calculation units 206 and 207 have different sizes, a desired value is set as each of the message sizes.

Digest registers 211 and 212 store the calculation results of the hash calculation units 206 and 207. The digest registers 211 and 212 include, e.g., items shown in FIG. 3D, respectively. Each hash value includes digest_A, digest_B, digest_C and digest_D shown in FIG. 3D. The digest values calculated by the hash calculation units 206 and 207 are supplied to a signature calculation unit 213, respectively. The signature calculation unit 213 calculates signature information from each digest value using a digital signature algorithm (e.g., SHA1 (Secure Hash Algorithm 1)). The signature calculation unit 213 signs the digest values using key information 214 unique to the digital camera, respectively. In the first exemplary embodiment, the signature information calculated from each digest value is alteration detecting information which used to detect an alteration of the image file data A.

In this way, the digest values are signed (encrypted) by using the key information 214 unique to the digital camera and converted into the signature information, respectively. The signature information converted from digest values are attached to the image file data A. A read/write unit 10 of the image sensing unit 1 stores the image file data A including signature information on the detachable semiconductor memory card 4 which is extracted from the digital camera.

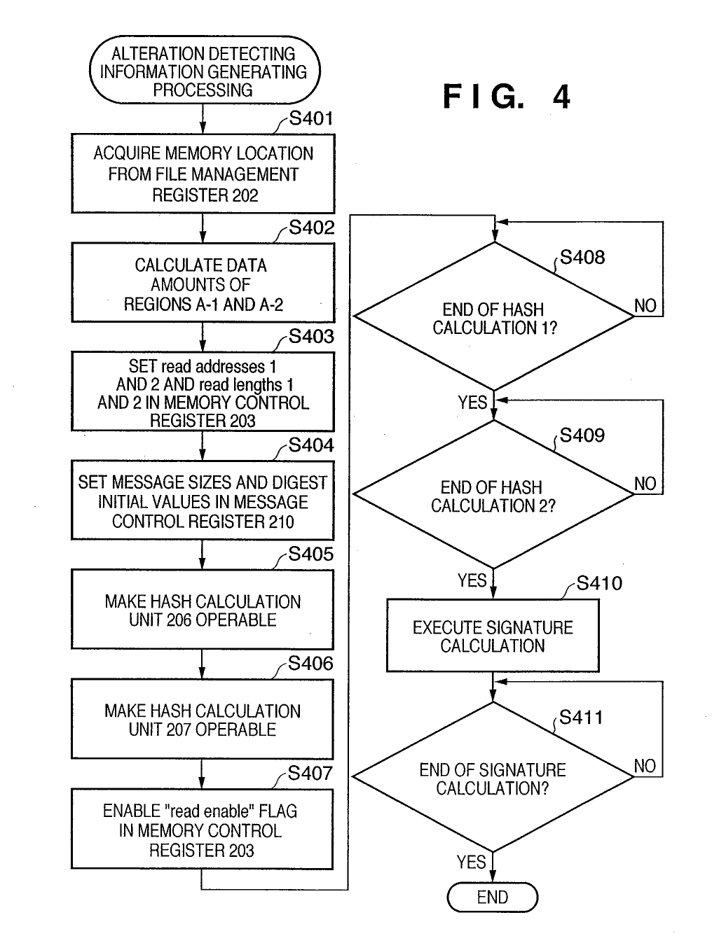

FIG. 4 is a flowchart for explaining the operation of the alteration detecting information generating unit 2 according to the first exemplary embodiment. In the first exemplary embodiment, the operation will be explained by exemplifying a case wherein the image file data A is divided into the divided image file data regions A-1 and A-2 and processed.

After the start of alteration detecting information generating processing, in step S401, the processing unit 201 acquires memory location information shown in FIG. 3A from the file management register 202. The process advances to step S402. The processing unit 201 calculates the data amounts of the divided image file data regions A-1 and A-2 on the basis of the acquired memory location information to divide the target image file data A into the two regions. This division can be either division into equal parts, in which the two divided image file data regions have equal data amounts, or division of any other type.

In step S403, the storage locations and read data amounts of the two regions on the work memory 205 are set in the memory control register 203 on the basis of the calculated data amounts. The storage locations are set as “read addresses 1 and 2”. The data amounts are set as “read lengths 1 and 2”.

In step S404, the processing unit 201 sets the message sizes and digest initial values in the message control register 210. It is possible to set different values for the hash calculation units 206 and 207 as the sizes of messages (divided image file data), as in setting of the read sizes in the work memory 205. However, the digest initial values remain as in step S404.

In steps S405 and S406, the hash calculation units 206 and 207 are initialized and set in an operable state. In FIG. 4, the “calcu(lator) enable 1” flag in FIG. 3C is enabled first. Then, the “calcu(lator) enable 2” flag is enabled.

The processing unit 201 sets the hash calculation units 206 and 207 in an operable state and requests to read out the image file data A. In FIG. 4, the “read enable” flag in the memory control register 203 is enabled in step S407.

Upon detecting the change in flag, the memory control register 203 sends the memory read set values set in step S403 to the memory control unit 204 and issues a data read request (status). Upon receiving the data read request, the memory control unit 204 reads out the target divided image file data regions A-1 and A-2 in the work memory 205 as needed. The FIFO buffers 208 and 209 temporarily store the readout data and sequentially send them to the hash calculation units 206 and 207. The hash calculation unit 206 calculates a hash value from data of the divided image file data region A-1, and the hash calculation unit 207 calculates a hash value from data of the divided image file data region A-2 in parallel with the hash calculation unit 206.

The memory control unit 204 controls switching of access to the divided image file data regions A-1 and A-2. This control is executable by various schemes. For example, access may alternately switch for each burst unit. If the work memory 205 is formed from an SDRAM, access may switch for each column.

The processing unit 201 generally detects the end of hash calculation by interrupt processing. However, the flowchart in FIG. 4 illustrates it not as interrupt processing but as part of the whole processing for the descriptive convenience. The processing unit 201 receives the end of processing by the hash calculation unit 206 in step S408 and the end of processing by the hash calculation unit 207 in step S409. The processing unit 201 recognizes that two digest values (corresponding to the divided image file data regions A-1 and A-2) are obtained.

Upon receiving the end of hash calculation, the process advances to step S410. In step S410, the signature calculation unit 213 calculates the signature information from each digest value. In step S411, the processing unit 201 detects the end of signature calculation, and the processing finishes.

The signature information are, e.g., attached to the end of the image file data A and written in the semiconductor memory card 4 together with the image file data A. Then, the data is taken out from the digital camera body. The semiconductor memory card 4 storing the image file data A (including regions A-1 and A-2) is inserted into a signal processing apparatus such as a PC (personal computer) to read out the data. In the PC, digest values are calculated from data of the divided image file data regions A-1 and A-2, and signature information are calculated from the digest values. The PC checks whether or not the signature information calculated in the PC matches the signature information attached to the image file data A. If the calculated signature information matches the attached signature information, the PC determined that the image file data A is not altered. If the calculated signature information and the attached signature information both corresponding to the divided image file data regions A-1 do not match, the PC determined that the divided image file data regions A-1 is altered. If the calculated signature information and the attached signature information both corresponding to the divided image file data regions A-2 do not match, the PC determined that the divided image file data regions A-2 is altered.

In the first exemplary embodiment, a digital camera has the alteration detecting information generating unit 2. However, the present invention is not limited to a digital camera. The alteration detecting information generating unit 2 is applicable to devices for electronically recording an image, including an image capturing apparatus (e.g., a scanner), a medical electronic camera. In the above description, image file data is divided into two parts. However, the present invention is applicable even when image file data is divided into three or four parts. In this case, a plurality of hash calculation units equal in number to divided parts are necessary. For example, if image file data is a color image signal, it is divided into a luminance signal component (Y component) and two color difference signal components (R-Y and B-Y components) or into three color signal components (R, G, and B components). As described above, the divided parts may be two or more. The present invention is applicable even when data is divided on the basis of signal contents.

The above-described embodiment can also be achieved by supplying a storage medium which records software program codes for implementing the functions of the above-described embodiment to a system or apparatus. That is, the above-described embodiment is achieved by causing the computer (or CPU or MPU) of the system or apparatus to read out and execute the program codes stored in the storage medium. In this case, the program codes read out from the storage medium implement the functions of the above-described embodiment by themselves, and the storage medium which stores the program codes constitutes the present invention.

Examples of the storage medium to supply the program codes are a flexible disk, hard disk, optical disk, magnetooptical disk, CD-ROM, CD-R, magnetic tape, nonvolatile memory card, and ROM.

The functions of the above-described embodiment are implemented even when the OS (Operating System) running on the computer partially or wholly executes actual processing on the basis of the instructions of the program codes.

In some cases, the program codes read out from the storage medium are written in the memory of a function expansion board inserted into the computer or a function expansion unit connected to the computer. The CPU of the function expansion board or function expansion unit partially or wholly executes actual processing on the basis of the instructions of the program codes, thereby implementing the functions of the above-described embodiment.

While the present invention has been described with reference to exemplary embodiments, it is to be understood that the present invention is not limited to the disclosed exemplary embodiments. The scope of the following claims is to be accorded the broadest interpretation so as to encompass all modifications and equivalent structures and functions.

This application claims the benefit of Japanese Patent Application No. 2006-193231, filed Jul. 13, 2006, which is hereby incorporated by reference herein in its entirety.

What is claimed is:

1. An image sensing apparatus comprising:
a dividing unit which divides image data into at least first and second divided image data;
a first hash calculation unit which calculates first hash value from the first divided image data;
a second hash calculation unit which calculates second hash value from the second divided image data, said second hash calculation unit being operated in parallel with said first hash calculation unit; and
an alteration detecting information generating unit which generates alteration detecting information from each of the first and second hash values.

2. The image sensing apparatus according to claim 1, wherein said alteration detecting information generating unit generates the alteration detecting information from each of the first and second hash values using a digital signature algorithm.

3. The image sensing apparatus according to claim 1, wherein said alteration detecting information generating unit generates the alteration detecting information from each of the first and second hash values using key information unique to said image sensing apparatus.

4. The image sensing apparatus according to claim 1, wherein the alteration detecting information generated from each of the first and second hash values are attached to the image data.

5. The image sensing apparatus according to claim 1, wherein the first divided image data includes a luminance component of the image data, and the second divided image data includes one of two color difference components of the image data.

6. The image sensing apparatus according to claim 1, wherein the first divided image data includes a first color component of the image data, and the second divided image data includes a second color component of the image data different from the first color component.

7. The image sensing apparatus according to claim 1, wherein said image sensing apparatus is a digital camera.
